(19) United States
(12) Patent Application Publication
(10) Pub. No.: US 2009/0091629 A1
(43) Pub. Date: Apr. 9, 2009

(54) TV/Movie actor identifcation device

(76) Inventor: Robert J. Casey, (US)

Correspondence Address: Robert J Casey, 20156 Darlington Drive, Montgomery Village, MD, 20886, US

(21) Appl. No.: 11/906,554

(22) Filed: Oct. 3, 2007

(51) Int. Cl. H04N 5/225; G06K 9/00; G06F 3/00

(52) U.S. Cl. 348/207.11; 382/118; 715/716

(57) ABSTRACT

The Invention is for aiding a person to identify the probable name of a TV or Movie actor by pointing the device at the full face of the actor and clicking a button which captures the image of the actor and compares the image against a database using facial recognition software. The list of probable answers is then either displayed on the device screen or on the TV screen next to the actor that was requested to be identified.

### BACKGROUND OF INVENTION

The field of use for this invention is any place there is a television/movie screen and the viewer wishes to know the Identification of a particular actor. The viewer can point and click the device at the screen where the actor's face is shown and the device can reveal the actor's identity.

Prior art is limited to Surveillance devices that tend to be used for identifying criminals at ports, or in train stations, or large population areas. There is also a web site that allows a person to download a photograph of himself/herself to see which actor they most closely resemble. But my invention is specifically for the identification of a movie or TV actor that is on the television or movie screen being watched and the viewer is curious about the actor's identity.

### SUMMARY OF THE INVENTION

A device that, when pointed at a screen where a actor's face is shown and a button is pressed, will reveal the actor's information either on the screen where the actor is located or on the screen of the device or both. It could provide identification audibly. The device utilizes readily available facial recognition software to perform its task.

### DESCRIPTION

The actor Identification device uses high pixel digital cameras to take a screenshot of the desired actor the viewer is trying to identify, simply by pointing the device at the full face of the actor, and clicking the “STAR NAME” button. The device will then compare the screenshot against a database using facial recognition software. A list of possible actor's will be listed either on screen by the actor or on the “Actor Identification” device screen. Voice software could also speak the available choices if desired.

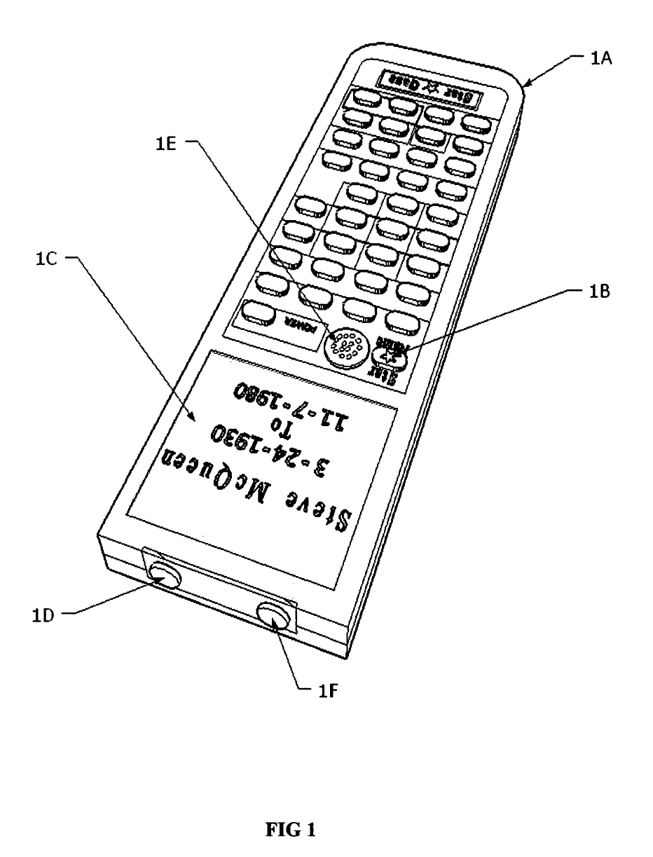

### BRIEF DESCRIPTION OF THE DRAWING (FIG. 1)

Aspects of illustrative, non-limiting embodiments of the present invention will become more apparent by describing in detail embodiments thereof with reference to the attached drawings in which:

1A. The Actor Identification Device (Integrated into a TV/DVD/VCR remote as shown).

1B. The Star Name Button, which activates the search.

1C. The Display screen with text and or images.

1D. High Pixel Camera lens.

1E. Speaker for voice operation.

1F. 2^{nd} High Pixel Camera lens if required.

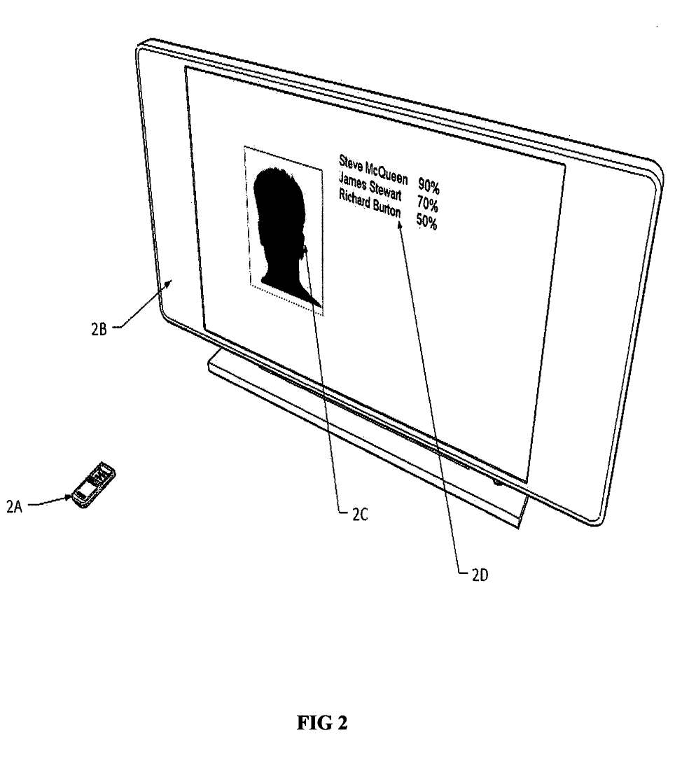

### BRIEF DESCRIPTION OF THE DRAWING (FIG. 2)

2A. The Actor Identification Device (pointed at the actor on the screen).

2B. The Screen.

2C. The front full face of the Actor to be identified.

2D. The “on screen listing” of actor choices with probability percentages.

### DETAIL DESCRIPTION

The following description of illustrative non-limiting embodiments of the invention discloses specific configurations and components. However, the embodiments are merely exemplary of the present invention, and thus, the specific features described below are merely used to more easily describe such embodiments and to provide an overall understanding of the present invention.

The actor identification device (1A) can be either integrated into a TV/DVD/VCR remote control (as shown) or as a stand alone device.

It would comprise of a star name button (1B) that, when pressed, takes a snapshot of the face that the device is pointed at.

It could have a screen (1C) that displays the actor's information once the actor identification device has searched a database and used facial recognition software to identify the best matches.

A high pixel camera lens (1D) and (1F) (if needed) that captures the image of the actor and sends it to the database for processing.

A speaker (1E) that emits a voice telling the viewer possible identities of the actor he/she inquired about. (The TV speakers could be utilized if need be).

The actor identification device (2A) is pointed at the desired subject (2C) on the screen (2B) and the star name button (1B) is pressed the image is processed and the likely matches (2D) are displayed on the Screen next to the subject (2C), giving a probability rating next to each name.

The database with which the actor image (2C) is compared to could be held in the actor identification device (1A, 2A) and when an internet signal is available could be updated periodically. This could also be performed manually with a standard docking station or USB drive. That, when is plugged into a standard computer and the correct website is entered, will start an automatic update.

The descriptions of the preferred embodiments set forth herein are provided to enable a person skilled in the art to make and use the present invention. Moreover, various modifications to those embodiments will be readily apparent to those skilled in the art. It will be appreciated that the above descriptions are intended only to serve as examples, and that many other embodiments are possible within the spirit and scope of the invention.

1. The combination of a camera, display, and one click button, which uses facial recognition software and a searchable database to take a screenshot of a TV or screen and identify the image of the actor on the screen.

2. The integration of a camera, display, and one click button, which uses facial recognition software and a searchable database to take a screenshot of a TV or screen and identify the image of the actor on the screen into a TV/DVD/VCR remote control for convenience.

3. The display of the identity of a actor on the screen next to the actor that the device is pointed at.
